(19) United States
(12) Patent Application Publication
(10) Pub. No.: US 2025/0089718 A1
(43) Pub. Date: Mar. 20, 2025

(54) SULFENTRAZONE COMPOSITION IN MICROEMULSION FORM

(71) Applicant: SURCOS IMPACT, Mamer (LU)

(72) Inventor: Felix Silvestre GALAN ROMANO, Buenos Aires (AR)

(21) Appl. No.: 18/018,708

(22) PCT Filed: Sep. 18, 2020
(86) PCT No.: PCT/IB2020/058743

§ 371 Date: Jan. 30, 2023

(30) Foreign Application Priority Data
Jul. 30, 2020 (AR) P20200102138

(51) Int. Cl. A01N 43/653; A01N 25/04; A01N 25/10; A01N 25/30; A01N 35/10; A01N 37/10; A01N 37/26; A01N 43/40; A01N 43/50; A01N 43/707; A01N 57/20; A01P 13/02

(52) U.S. Cl. CPC A01N 43/653; A01N 25/04; A01N 25/10; A01N 25/30; A01N 35/10; A01N 37/10; A01N 37/26; A01N 43/40; A01N 43/50; A01N 43/707; A01N 57/20; A01P 13/02

(57) ABSTRACT

A sulfentrazone composition in the form of a microemulsion includes 5-15% weight by volume of sulfentrazone, an aprotic dipolar organic solvent including 46-50% w/v, a polar solvent including from 0-4% w/v, wetting agents 20% or 41% w/v, a coadjuvant from 0-5% w/v, and a nonionic surfactant from 0-3.5% w/v, adjuvant from 0-17.5% w/v and dispersing agents from 0-2% w/v. The composition showed a reduction in the application dose compared to other concentrated compositions of the same active ingredient, and by virtue of the combination of its other formulation components that the investigators used for its realization, formulation offered protection against physicochemical losses (evaporation, rolling, etc.), absorption rate improvement, significant reduction of environmental impact variables, drastic reduction of solvent evaporation, allowing keeping the active ingredients in liquid phase, allowing hydrophobic active ingredients to be solubilized in water, a large increase in the Surface/Volume ratio and controlled release of active ingredients.

### CROSS-REFERENCE TO RELATED APPLICATIONS

This application is the U.S. national phase of International Application No. PCT/IB2020/058743 filed Sep. 18, 2020, which designated the U.S. and claims priority to AR P20200102138 filed Jul. 30, 2020, the entire contents of each of which are hereby incorporated by reference.

### BACKGROUND OF THE INVENTION

### Field of the Invention

The present invention is included in the field of herbicidal formulations of the chemical compound known as sulfentrazone or sulfentrazone 2′,4′-Dichloro-5′-(4-difluoromethyl-4,5-dihydro-3-methyl-5-oxo-1H1,2,4-triazol-1-yl) methanesulfonanilide especially in the form of a microemulsion at low concentrations.

The object of the present invention is to provide a herbicidal composition of the active ingredient sulfentrazone at low concentration from 5 to 15% w/v in the form of a microemulsion that unexpectedly requires a lower application dose of the active ingredient per unit area of crop to which it is applied, achieving equal or better benefits than its concentrated commercial formulations.

### Description of the Related Art

Sulfentrazone is included within the group of herbicides that inhibit the protoporphyrinogen oxidase enzyme in plants, which is a chloroplast enzyme, which oxidizes protoporphyrinogen to produce protoporphyrin IX. This product is important as it is the precursor molecule for chlorophylls (necessary for photosynthesis) and heme groups (necessary in electron transfer chains).

It is common to find in the agrochemical market the herbicide sulfentrazone marketed as emulsifiable concentrate (EC) at 36.5% and 50%, in dispersible granules at 46.9%, 47% and 75% (WG) or in concentrated flowable suspension (SC) at 39.6% or 480 g/L, in general it is achieved as a technical drug for formulation of up to 92.2% (91% minimum).

Sulfentrazone is a product known in the prior art since 1989 patented by FMC in the U.S. Pat. No. 4,818,275 corresponding to the patent of revalidation in Argentina AR246738A1 available to the public as of Sep. 30, 2019.

### SUMMARY OF THE INVENTION

The present invention contemplates a sulfentrazone composition in the form of a micro-emulsion comprising from 5 to 15% weight by volume of sulfentrazone, a dipolar aprotic organic solvent comprising from 46 to 50% w/v, a polar solvent comprising from 0 to 4.0% w/v, wetting agents 20% or 41% w/v, a coadjuvant from 0 to 6% w/v, and a nonionic surfactant from 0 to 3.5% w/v, adjuvant from 0 to 17.5% w/v and dispersing agents from 0 to 2% w/v.

In said sulfentrazone composition in the form of a microemulsion, the aprotic dipolar organic solvent is N-methylpyrrolidone.

In such a sulfentrazone composition in the form of a microemulsion, the polar solvent is glacial acetic acid or water.

In said sulfentrazone composition in the form of a microemulsion, the wetting agent is polyethylene nonyl phenol 10.06% w/w or wetting agent based on saturated and unsaturated fatty acids dimethylaminopropalamide.

In such a sulfentrazone composition in the form of a microemulsion, the nonionic surfactant comprises castor oil ethoxylated with 36 moles of ethylene oxide.

In said sulfentrazone composition in the form of a microemulsion, the coadjuvant is a fatty acid methyl ester from soybean oil.

In such a sulfentrazone composition in the form of a microemulsion, the dispersing agent is polymethylmethacrylate-polyethylene glycol graft copolymer.

In said sulfentrazone composition in the form of a microemulsion, the adjuvant is selected from fatty tallow alkyl amine ethoxylated with 15 moles of ethylene oxide or coconut fatty amine ethoxylated with 10-15 moles of ethylene oxide.

In the sulfentrazone composition in the form of a microemulsion according to the previous variants, it comprises the following ratio of components: 10.0% w/v sulfentrazone, 48% w/v N-methylpyrrolidone, 15.0% w/v coconut fatty amine ethoxylated with 10-15 moles of ethylene oxide, 20% w/v polyethylene nonyl phenol 10.06% w/w, 5% w/v soybean oil fatty acid methyl ester, 2% w/v polymethylmethacrylate-polyethylene glycol graft copolymer, 3.5% w/v castor oil ethoxylated with 36 moles of ethylene oxide.

The sulfentrazone composition in the form of a microemulsion according to one of the preferred variants comprises the following ratio of components: 10.0% w/v sulfentrazone, 46% w/v N-methylpyrrolidone, 41% w/v wetting agent based on saturated and unsaturated fatty acids dimethylaminopropalamide and 3.5% w/v glacial acetic acid.

The sulfentrazone composition in the form of a microemulsion according to one of the preferred embodiments comprises the following ratio of components: 10.0% w/v sulfentrazone, 46% w/v N-methylpyrrolidone, 17.5% w/v coconut fatty amine ethoxylated with 10-15 moles of ethylene oxide, 21.5% w/v polyethylene nonyl phenol 10.06% w/w, 5% w/v soybean oil fatty acid methyl ester, and 2% w/v polymethylmethacrylate-polyethylene glycol graft copolymer.

In one of the preferred embodiments, the composition sulfentrazone in the form of a microemulsion according to the present comprises the following ratio of components: 5.0% w/v sulfentrazone, 48% w/v N-methylpyrrolidone, 15.0% w/v coconut fatty amine ethoxylated with 10-15 moles of ethylene oxide, 20.0% w/v polyethylene nonyl phenol 10.06% w/w, 6% w/v soybean oil fatty acid methyl ester, 2% w/v polymethylmethacrylate-polyethylene glycol graft copolymer, 3.5% w/v castor oil ethoxylated with 36 moles of ethylene oxide and 4% w/v water.

In another of the preferred embodiments, the sulfentrazone composition in the form of a microemulsion includes the following ratio of components 10.0% w/v sulfentrazone, 46% w/v N-methylpyrrolidone, 15.0% w/v coconut fatty amine ethoxylated with 10-15 moles of ethylene oxide, 20.0% w/v polyethylene nonyl phenol 10.06% w/w, 5% w/v soybean oil fatty acid methyl ester, 2% w/v polymethylmethacrylate-polyethylene glycol graft copolymer, 3.5% w/v castor oil ethoxylated with 36 moles of ethylene oxide and 2% w/v water.

And in another preferred embodiment, the sulfentrazone composition in the form of a microemulsion according to the present comprises the following ratio of components 15.0% w/v sulfentrazone, 48% w/v N-methylpyrrolidone, 15.0% w/v coconut fatty amine ethoxylated with 10-15 moles of ethylene oxide, 20.0% w/v polyethylene nonyl phenol 10.06% w/w, 1% w/v soybean oil fatty acid methyl ester, 2% w/v polymethylmethacrylate-polyethylene glycol graft copolymer, 3.5% w/v castor oil ethoxylated with 36 moles of ethylene oxide and 1% w/v water.

The sulfentrazone composition in the form of a microemulsion according to any of the previous embodiments is combined with compositions of glyphosate 11% ME, glyphosate potassium salt 66.2% w/v SL, 2.4 D, 2.4 D salt of dimethyl amine, acetochlor, metribuzin, clethodim, imazethapyr and paraquat before being diluted with water for subsequent application.

The sulfentrazone composition in the form of a microemulsion according to the previous embodiment, is combined with glyphosate 11% ME, and/or glyphosate potassium salt 66.2% w/v SL, and/or 2.4 D 30% w/v ME, and/or 2.4 D dimethyl amine salt 60% w/v SL, and/or acetochlor 90% w/v EC, and/or metribuzin 20% w/v ME, and/or clethodim 24% w/v ME, and/or clethodim 24% w/v EC, and/or imazethapyr 4.5% w/v ME and/or paraquat 27% w/v SL.

In another embodiment, in the sulfentrazone composition in the form of a microemulsion as indicated above, the combination ratio of sulfentrazone composition 10% w/v ME:glyphosate composition 11% w/v ME in a binary mixture is 2.5:3.0 v/v.

In another embodiment, the sulfentrazone composition in the form of a microemulsion as indicated above, the combination ratio of sulfentrazone composition 10% w/v ME:glyphosate potassium salt composition 66.2% w/v SL in a binary mixture is 2.5:2.0 v/v.

In another embodiment, the sulfentrazone composition in the form of a microemulsion as indicated above, the combination ratio of the sulfentrazone composition 10% w/v ME: 2.4 D composition 30% w/v ME in a binary mixture is 2.5:1.0 v/v.

In another embodiment, the sulfentrazone composition in the form of a microemulsion as indicated above, the combination ratio of sulfentrazone composition 10% w/v ME: 2.4 D dimethyl amine salt (DMA) composition 60% w/v SL or acetochlor 90% w/v EC in a binary mixture is 2.5:1.2 v/v.

In another embodiment, the sulfentrazone composition in the form of a microemulsion as indicated above, the combination ratio of sulfentrazone 10% w/v ME: 2.4 D composition 8% w/V ME+Glyphosate 11% w/V ME in a mixture is 2.5:4.0 v/v.

In another embodiment, the sulfentrazone composition in the form of a microemulsion as indicated above, the combination ratio of sulfentrazone composition 10% w/v ME:glyphosate Potassium Salt composition 66.2% w/V SL: 2.4 D composition 30% w/V ME in a ternary mixture is 2.5:2:1.

In another embodiment, the sulfentrazone composition in the form of a microemulsion as indicated above, the combination ratio of sulfentrazone composition 10% w/v ME:metribuzin composition 20% w/v ME:glyphosate composition 11% w/v ME: 2,4D composition 30% w/v ME:clethodim composition 24% w/v ME is in a mixture of five components 2.5:1.5:3:1:1.2.

In another embodiment, the sulfentrazone composition in the form of a microemulsion as indicated above, the combination ratio of sulfentrazone composition 10% w/v ME:metribuzin composition 48% w/v:Glyphosate Potassium Salt composition 66.2% w/V SL: 2.4 D salt DMA composition 60% w/V SL:clethodim composition 24% EC:Acetochlor composition 90% w/v EC in a mixture of six components is 2.5:1:2:1.2:1.2:1.2.

In another embodiment, the sulfentrazone composition in the form of a microemulsion as indicated above, the combination ratio of sulfentrazone composition 10% w/v ME:Imazethapyr composition 4.5% w/v ME:Glyphosate composition 11% w/v ME: 2,4D composition 30% w/v ME in a quaternary mixture is 2.5:1:3:1.

In another embodiment, the sulfentrazone composition in the form of a microemulsion as indicated above, the combination ratio of sulfentrazone composition 10% w/v ME:metribuzin composition 20% w/v ME:Glyphosate potassium salt composition 66.2% w/v SL: 2.4D composition 30% w/v ME in a quaternary mixture is 2.5:1.5:2:1.

In another embodiment, the sulfentrazone composition in the form of a microemulsion as indicated above, the combination ratio of sulfentrazone composition 10% w/v ME:Clethodim composition 24% w/v ME:Glyphosate composition 11% w/v ME: 2,4D composition 30% w/v ME:Metribuzin composition 20% w/v ME in a mixture of five components is 2.5:1.2:3:1:1.5

In another embodiment, the sulfentrazone composition in the form of a microemulsion as indicated above, the combination ratio of sulfentrazone composition 10% w/v ME:Clethodim composition 24% w/v ME:Glyphosate Potassium Salt composition 66.2% w/v SL: 2.4 D 30% p/V ME in a quaternary mixture is 2.5:1.2:2:1.

In another embodiment, the sulfentrazone composition in the form of a microemulsion as indicated above, the combination ratio of sulfentrazone composition 10% w/v ME:Clethodim composition 24% w/v ME:Glyphosate Potassium Salt composition 66.2% w/v SL: 2.4 D DMA salt 60% w/V SL in a quaternary mixture is 2.5:1.2:2:1.

In another embodiment, the sulfentrazone composition in the form of a microemulsion as indicated above, the combination ratio of sulfentrazone composition 10% w/v ME:Paraquat composition 27% w/v SL in a binary mixture is 2.5:1.2.

### BRIEF DESCRIPTION OF THE DRAWINGS

In order to make the object of present invention more understandable, it has been illustrated with the following figures:

FIG. 1: It is showed the treatments under the conditions in which the test was developed with different doses of the new formulation of sulfentrazone, versus the conventional one, despite using a lower amount of active ingredient per hectare, the residual control of yuyo colorado and other species such as black purslane and purslane was excellent.

FIG. 2: It is showed rainfalls during the period under study of campaign 16-17-partial and historical comparison.

### DESCRIPTION OF THE PREFERRED EMBODIMENTS

The present invention relates to sulfentrazone compositions in the form of a microemulsion with a concentration of the active ingredient of approximately 10% w/v.

Technical grade sulfentrazone (GT) is a brown solid that was marketed at a concentration of up to 92.2% w/w with a very low solubility in water of 238 ppm (mg/L) at 20° C. Advances in the chemical synthesis of the sulfentrazone product made it possible to obtain it at higher concentrations of around 97% w/w for said product in technical grade.

Microemulsion compositions are formulations containing very small emulsified organic solvent droplets, which gives rise to a transparent formulation that is thermodynamically stable in a wide range of temperatures due to the fact that the droplets have a very small size that varies in a range of 0.01 μm to 0.05 μm in diameter. Therefore, unlike other emulsion systems in which the oily droplets can slowly coalesce over time causing phase separation, this does not happen in microemulsion formulations.

Microemulsions are made up of immiscible liquids and appropriate amounts of surfactant and cosurfactant.

The present sulfentrazone microemulsion formulation is composed of immiscible liquids that comprise an organic solvent with a water-soluble formulation such as N-methylpyrrolidone. N-methylpyrrolidone comprises an aprotic dipolar organic solvent.

Among the surfactants for the sulfentrazone microemulsion of the present development, the following are preferred: as a non-ionic surfactant, castor oil ethoxylated with 36 moles of ethylene oxide, for example the one marketed under the name Emulsogen® EL 360.

Selected compounds of fatty tallow alkyl amine ethoxylated with 15 moles of ethylene oxide known as Genamin® T 150 or coconut amine ethoxylated with 10-15 moles of ethylene oxide known as Genamin® C 150 are used as formulation adjuvants, coconut amine ethoxylated with 15 moles of ethylene oxide T150 is preferred, the characteristics of which are described below:
Physical state: liquid above 25° C.
pH: alkaline
Amine value: 55-75
HLB: 15.43
Maximum humidity: <1%

The sulfentrazone microemulsion also contains fatty acid methyl esters such as for example soybean oil (EMAG) as coadjuvants; the coadjuvants give them a power of anti-evaporation and adherence to agricultural applications; this property is essential to avoid the separation into phases of active ingredients within the mixing tank at the time of application of agrochemicals.

Polyethylene nonyl phenol 10.06% w/w or wetting agent based on saturated and unsaturated fatty acids dimethylaminopropalamide is also added as a wetting agent component of the formulation.

Characteristics of the wetting agent based on saturated and unsaturated fatty acids dimethylaminopropalamide:
Physical state: liquid above 20° C. and amber waxy solid below 20° C.
Odor: characteristic of amines
pH value: 11, 7-12, 9 at 20° C.
Melting point: 20° C.
Flammability: not flammable
Density: 0.9 g/cm³ (20° C.)
Solubility in water: emulsifies
Free amines: <4 meq/g
Refractive index: 1.472

The formulation of aqueous suspensions of pesticides requires the use of powerful dispersing agents that keep the particles in a dispersed state by forming protective layers around them, based on the above, a polymethylmethacrylate-polyethylene glycol graft copolymer is added to the sulfentrazone microemulsion formulation, that acts as a dispersant marketed for example as Atlox® 4913.

The formulation of sulfentrazone in the form of a microemulsion also requires the addition of a polar solvent; among the polar solvents to be added, water and glacial acetic acid are preferred.

The addition of glacial acetic acid as a polar solvent modifies the pH of the sulfentrazone microemulsion making it more stable.

Based on the previous components, the following microemulsions were prepared where the amounts in % w/v are described in the following tables:

### 1) Sulfentrazone Micro Emulsion 10.0% w/v

| Component | % w/v |
|---|---|
| Sulfentrazone (GT) 97% | 10.30 |
| N-methylpyrrolidone | 48 |
| EMAG | 5.0 |
| EmulsogenEL 360 | 3.5 |
| Atlox ® 4913 | 2.0 |
| T 150 | 15.0 |
| Glacial acetic acid | 0 |
| wetting agent based on saturated and | 0 |
| unsaturated fatty acids | |
| dimethylaminopropalamide | |
| Polyethylene nonyl | 20.0 |
| phenol 10.06% w/w | |

### 2) Sulfentrazone Microemulsion 10.0% w/v

| Component | % w/v |
|---|---|
| Sulfentrazone (GT) 97% | 10.30 |
| N-methylpyrrolidone | 46.0 |
| EMAG | 0 |
| Emulsogen EL 360 | 0 |
| Atlox ® 4913 | 0 |
| T 150 | 0 |
| Glacial acetic acid | 3.5 |
| wetting agent based on | 41 |
| saturated and | |
| unsaturated fatty acids | |
| dimethylaminopropalamide | |
| Polyethylene nonyl | 0 |
| phenol 10.06% w/w | |

### 3) Sulfentrazone Microemulsion 10.0% w/v

| Component | % w/v |
|---|---|
| Sulfentrazone (GT) 97% | 10.30 |
| N-methylpyrrolidone | 46.0 |
| EMAG | 5.0 |
| Emulsogen EL 360 | 0 |
| Atlox ® 4913 | 2.0 |
| T 150 | 17.5 |
| Glacial acetic acid | 0 |
| wetting agent based on | 0 |
| saturated and | |
| unsaturated fatty acids | |
| dimethylaminopropalamide | |
| Polyethylene nonyl | 21.5 |
| phenol 10.06% w/w | |

### 4) Sulfentrazone Microemulsion 15.0% w/v

| Component | % w/v |
|---|---|
| Sulfentrazone (GT) 97% | 15.46 |
| N-methylpyrrolidone | 48.0 |
| EMAG | 5.0 |
| Emulsogen EL 360 | 3.5 |
| Atlox ® 4913 | 2.0 |
| T 150 | 17.5 |
| Water | 1 |
| wetting agent based on | 0 |
| saturated and | |
| unsaturated fatty acids | |
| dimethylaminopropalamide | |
| Polyethylene nonyl | 21.5 |
| phenol 10.06% w/w | |

### 5) Sulfentrazone Microemulsion 10.0% w/v

| Component | % w/v |
|---|---|
| Sulfentrazone (GT) 97% | 10.30 |
| N-methylpyrrolidone | 46.0 |
| EMAG | 5.0 |
| Emulsogen EL 360 | 3.5 |
| Atlox ® 4913 | 2.0 |
| T 150 | 15.0 |
| Water | 2 |
| wetting agent based on | 0 |
| saturated and | |
| unsaturated fatty acids | |
| dimethylaminopropalamide | |
| Polyethylene nonyl | 20.0 |
| phenol 10.06% w/w | |

### 6) Sulfentrazone Microemulsion 5.0% w/v

| Component | % w/v |
|---|---|
| Sulfentrazone (GT) 97% | 5.15 |
| N-methylpyrrolidone | 48.0 |
| EMAG | 6.0 |
| Emulsogen EL 360 | 3.5 |
| Atlox ® 4913 | 2.0 |
| T 150 | 15.0 |
| Water | 4 |
| wetting agent based on | 0 |
| saturated and | |
| unsaturated fatty acids | |
| dimethylaminopropalamide | |
| Polyethylene nonyl | 20.0 |
| phenol 10.06% w/w | |

The previous formulations in the form of microemulsion in the range of 5 to 15% w/v showed excellent stability, adequately passing the emulsion tests in water without separation of components.

Comparative Tests The following tests were carried out with the previous microemulsion formulations:
1) Comparative test of herbicides in soybean Pre-emergence with sulfentrazone 10.0% ME in the province of Chaco (Argentine Republic)

### Introduction

Among the weed communities, which affect agricultural systems today, among broadleaves, there are several species of the genus Amaranthus, native to tropical to warm temperate regions. In the province of the Argentine Republic known as Chaco, there are numerous genera, but the most abundant and frequent species are A. hybridus and A. palmeri.

Species with resistance to ALS enzyme-inhibiting herbicides and glyphosate.

These species have high fertility, with high seed production, which forces the management and control to act on the seed bank, with residual herbicides with different mechanisms of action. Among the chemical alternatives, there are the Protoporphyrinogen oxidase (PPO) enzime-inhibiting herbicides of residual action such as sulfrentrazone used in soybean crop.

Investigators, based on the commitment to protect the environment and the applicator without reducing the efficiency of agrochemical control, evaluated the control efficiency of the sulfentrazone formulation 10% ME, for the control of yuyo colorado (A. hybridus and A palmeri).

### Materials and Methods

Faced with the same problem to deal with as pre-emergent test 4 in soybean, this test was then set up in a soil of the Chaco Series (argiustoludic), of the clay family.

Horizon A1 of 7 cm and A2 of 7 to 23 cm, 49.3% of clay, 89.6 of silt and 4.6 of sand and 3% of organic matter.

### Treatments:

1. Without control
2. Sulfentrazone 10% ME 2.5 L ha⁻¹
3. Sulfentrazone 10% ME 3.0 L ha⁻¹
4. Sulfentrazone 10% ME 3.5 L ha⁻¹
5. Sulfentrazone 50 SC % 1.0 L ha⁻¹

The treatments were arranged in a randomized complete block design with four replications, 3 m wide by 10 m long plots.

The applications were made 24 hours after sowing, on Dec. 14, 2016 at 09:00 a.m., with a manual backpack, spraying a volume equivalent to 170 L ha⁻¹, the meteorological conditions were 21.3° C. of average temperature, 55% relative humidity, SE wind at 6.9 km/hour.

Evaluations were carried out 15 and 35 days after application, using a visual scale from 0% (no control) to 100% (total control).

### Results and Discussion

Table No. 1 details the rainfall in the month of December, before and after the application and sowing of the soybean crop, which totaled 93.6 mm and the day after application 51 mm, more than enough for its incorporation and activation in the soil.

15 days after the application, the control of yuyo colorado was excellent, in all the doses of the 10% ME formulation and that of sulfrentrazone 50% SC and of other broadleaf species such as Portulaca oleracea and Trianthema portulacastrum.

After 35 days, the control of yuyo colorado and the other broadleaves continued to be excellent, creating empty niches that allowed the establishment of grasses, due to lack of a product that controls them from seed such as Leptochloa filiformis, Digitaria sanguinalis, Eleusine indica and Digitaria Insularis.

Subsequent evaluations were not carried out, given that the crop quickly closed the spacing of furrows and due to an abundant development of grasses that forced the application of a selective herbicide for their control.

TABLE NO. 1
Rainfalls prior to application and after
application.

| December | | January | |
|---|---|---|---|
| Day | mm | Day | Mm |
| 2 | 41.5 | 5 | 38.6 |
| 6 | 10.4 | 7 | 0.4 |
| 7 | 15.5 | 10 | 2.8 |
| 8 | 10.0 | 24 | 6.6 |
| 9 | 0.8 | 26 | 0.6 |
| 10 | 11.4 | | |
| 13 | 4.0 | | |
| 19 | 51.0 | | |
| 26 | 3.8 | | |
| 27 | 33.2 | | |
| 31 | 14.5 | | |

Subsequent periodic inspections, and at the end of the cycle, the emergence of broadleaf weeds was scarce.

### Conclusions

The Sulfentrazone 10% ME formulation had an efficient control from 15 dda (days after application) and was maintained until at least up to 35 dda on the weeds evaluated in the test. The 2.5 l/ha dose of Sulfentrazone 10% ME (treatment 2) showed the same performance compared to the doses of the commercial control (Sulfentrazone 50% SC 1 l/ha). From these results we can conclude that the reduction of active ingredient per hectare translates into 50% compared to the chemical control of proven efficacy in the market.

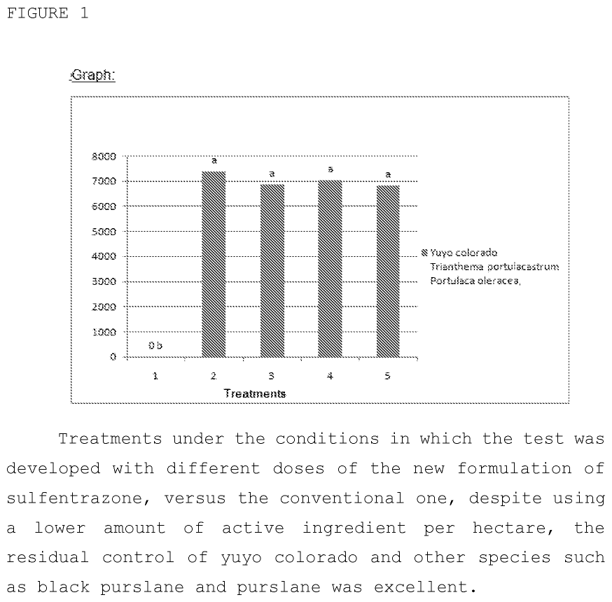

In FIG. 1 is showed treatments under the conditions in which the test was developed with different doses of the new formulation of sulfentrazone, versus the conventional one, despite using a lower amount of active ingredient per hectare, the residual control of yuyo colorado and other species such as black purslane and purslane was excellent.

Annex: Statistical analysis
To comply with the ANOVA assumptions, the % values were
transformed to the square root of the arc sine
ANOVA procedure
Class level information

| Class | Levels | Values |
|---|---|---|
| bloc | 4 | 1 2 3 4 |
| trat | 4 | 2 3 4 5 |

| | |
|---|---|
| Number of observations read | 16 |
| Number of observations used | 16 |

ANOVA procedure

| Dependent variable: | | Total control 15 dda | | | |
|---|---|---|---|---|---|
| | | | Mean | F- | |
| Source | DF | Square Sum | square | Value | Pr > F |
| Model | 6 | 1009599.000 | 168266.500 | 1.72 | 0.2237 |
| Error | 9 | 882375.000 | 98041.667 | | |
| Total correct | 15 | 1891974.000 | | | |
| | R-square | Var Coef | MSE Root | Mean ct | |
| | 0.533622 | 4,454949 | 313,1161 | 7028, 500 | |
| | | | Mean | F- | |
| Source | DF | ANOVA SS | square | Value | Pr > F |
| bloc | 3 | 256144.5000 | 85381.5000 | 0.87 | 0.4912 |
| trat | 3 | 753454.5000 | 251151.5000 | 2.56 | 0.1199 |

ANOVA procedure
Tukey's Studentized Range Test (HSD) for Total Control
NOTE: This test checks for a Type I experimentwise error rate,
but typically has a Type II error rate higher than REGWQ.

| | |
|---|---|
| Alpha | 0.05 |
| Degrees of freedom error | 9 |
| Mean square error | 98041.67 |
| Critical value of the studentized range | 4.41490 |
| Minimum significant difference | 691.19 |

Means with the same letter are not significantly different.

| Tukey | | Number of | |
|---|---|---|---|
| Grouping | Mean | observations | trat |
| A | 7378.5 | 4 | 2 |
| A | 7040.3 | 4 | 4 |
| A | 6859.8 | 4 | 3 |
| A | 6835.5 | 4 | 5 |

2) Evaluation of sulfentrazone 10.0% microemulsion in pre-emergence treatments on soybean crop in full coverage, evaluated in the control of broadleaf weeds common in the Pampas region and susceptible to the chemical molecule under study, in the province of Santa Fe (Argentine Republic)

Test design: 10 m×4 m plots with 3 repetitions per treatment.

### Treatments Proposed:

| Treatment No. | TREATMENT |
|---|---|
| 1 | Absolute control: no control |
| 2 | Sulfentrazone 10% (ME) 2.5 lt/ha |
| 3 | Sulfentrazone 10% (ME) 3.0 lt/ha |
| 4 | Sulfentrazone 10% (ME) 3.5 lt/ha |
| 5 | Chemical control: Sulfentrazone |
| | 50% (SC) 1.0 lt/ha |

### Work Report:

a. CULTIVATION: Immediate application after sowing the first soybean crop, predecessor Soybean from the second season '15-'16. Direct sowing lot with serious problems of water excesses in pre-harvest of the predecessor crop and fallow period due to the presence of shallow aquifer. Two previous applications for weed control, on long and short fallow, based on Glyphosate. Treatments applied on Nov. 12, 2016.
b. SITE: San Martin de las Escobas, San Martin Department, Province of Santa Fe, soil use class IVwe, environment class 2.
c. CLIMATIC CHARACTERISTICS: Good climatic conditions conducive to the abundant birth of weeds typical of the plot. History of weed controls prior to the application of the treatments under study, highly conditioned by excess water and the rise of the aquifer. Temperatures and ambient humidity above the historical values for the months surveyed.

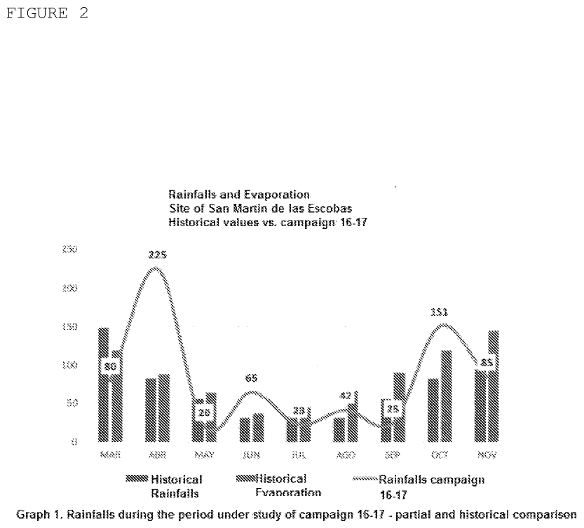

In the Graph 1 of FIG. 2 it is showed rainfalls during the period under study of campaign 16-17-partial and historical comparison.
d. WEED MONITORING: The initial survey was carried out by touring the plot of 52 hectares in total every fortnight, walking it in an X form and making the reading in a radius of 2 meters per sample, in an approximate total of 1 sample every 10 hectares.

The plot under study is clean of problem weeds due to previous controls carried out in a timely manner in the long fallow stage, despite the known history regarding its usual weed profile.

Application at the time of sowing the crop and sampling at 7 and 15 days after application.

The percentage of emergence of seedlings susceptible to control, after the application of the treatments, with respect to the absolute control, is recorded in each treatment strip.
e. EVALUATION OF APPLICATION:

| | Amaranthus | | | Portulaca | | | | | | Quenopodium | | |
|---|---|---|---|---|---|---|---|---|---|---|---|---|
| | ssp. | | | oler. | | | Conyza bon. | | | alb. | | |
| | 7DDA | % test | DR | 7DDA | % test | DR | 7DDA | % test | DR | 7DDA | % test | DR |
| Absolute control | 5 | 100 | 0 | 4 | 100 | 0 | 5 | 100 | 0 | 4 | 100 | 0 |
| Sulfentrazone 10% | 1 | 20 | 5 | 1 | 25 | 4 | 1 | 29 | 3 | 0 | 9 | 5 |
| (ME) 2.5 lt/ha | | | | | | | | | | | | |
| Sulfentrazone 10% | 0 | 7 | — | 0 | 0 | — | 0 | 7 | 4 | 0 | 0 | — |
| (ME) 3.0 lt/ha | | | | | | | | | | | | |
| Sulfentrazone 10% | 0 | 0 | — | 0 | 0 | — | 0 | 0 | — | 0 | 0 | — |
| (ME) 3.5 lt/ha | | | | | | | | | | | | |
| Sulfentrazone 50% | 0 | 7 | 5 | 2 | 42 | 5 | 2 | 36 | 3 | 0 | 9 | 5 |
| (ME) 1.0 lt/ha | | | | | | | | | | | | |

| | Amaranthus | | | Portulaca | | | | | | Quenopodium | | |
|---|---|---|---|---|---|---|---|---|---|---|---|---|
| | ssp. | | | oler. | | | Conyza bon. | | | alb. | | |
| | 15DDA | % test | DR | 15DDA | % test | DR | 15DDA | % test | DR | 15DDA | % test | DR |
| Absolute control | 6 | 100 | 0 | 5 | 100 | 0 | 5 | 100 | 0 | 4 | 100 | 0 |
| Sulfentrazone 10% | 2 | 29 | 5 | 2 | 31 | 5 | 1 | 21 | 3 | 1 | 17 | 5 |
| (ME) 2.5 lt/ha | | | | | | | | | | | | |
| Sulfentrazone 10% | 0 | 6 | 5 | 1 | 13 | 5 | 0 | 0 | — | 0 | 0 | — |
| (ME) 3.0 lt/ha | | | | | | | | | | | | |
| Sulfentrazone 10% | 0 | 0 | — | 0 | 0 | — | 0 | 0 | — | 0 | 0 | — |
| (ME) 3.5 lt/ha | | | | | | | | | | | | |
| Sulfentrazone 50% | 1 | 24 | 5 | 1 | 13 | 5 | 1 | 14 | 3 | 0 | 8 | 5 |
| (ME) 1.0 lt/ha | | | | | | | | | | | | |

Individuals present per square meter, average value of the three repetitions of each treatment (total and percentage)

(DR): Damage to the remaining plant structures of the emerged/surviving individuals at 7 and 15 days post-application, average of all repetitions. Scale from 0 (no damage) to 5 (live weed but with no healthy remaining structures).
f. STATISTICAL ANALYSIS 7 DDA and 15 DDA:

| Variable | N | R* | R* Aj | CV |
|---|---|---|---|---|
| Amar7 | 15 | 0.94 | 0.92 | 43.30 |
| Amar15 | 15 | 0.96 | 0.94 | 28.69 |

Table of Variance Analysis (SC type III)

| F.V. | SC | gl | CM | F | p-value |
|---|---|---|---|---|---|
| Model | 52.00 | 4 | 13.00 | 39.00 | <0.0001 |
| Treatment | 52.00 | 4 | 13.00 | 39.00 | <0.0001 |
| Error | 3.33 | 10 | 0.33 | | |
| Total | 55.33 | 14 | | | |
| Model | 61.73 | 4 | 15.43 | 57.87 | <0.0001 |
| Treatment | 61.73 | 4 | 15.43 | 57.87 | <0.0001 |
| Error | 2.67 | 10 | 0.27 | | |
| Total | 64.40 | 14 | | | |
| Test: LSD Fisher Alpha = 0.05 DMS = 1. 05035 | | | | | |
| Error: 0.3333 gl: 10 | | | | | |
| Treatment | | Means | n | E.E. | |
| Control | | 5.00 | 3 | 0.33 | A |
| Sulfent10ME | 2.5 | 1.00 | 3 | 0.33 | B |
| Sulfent50SC | 1.0 | 0.33 | 3 | 0.33 | B |
| Sulfent10ME | 3.0 | 0.33 | 3 | 0.33 | B |
| Sulfent10ME | 3.5 | 0.00 | 3 | 0.33 | B |
| Control | | 5.67 | 3 | 0.30 | A |
| Sulfent10ME | 2.5 | 1.67 | 3 | 0.30 | B |
| Sulfent50SC | 1.0 | 1.33 | 3 | 0.30 | B |
| Sulfent10ME | 3.0 | 0.33 | 3 | 0.30 | C |
| Sulfent10ME | 3.5 | 0.00 | 3 | 0.30 | C |

Means with a common letter are not significantly different (p > 0.05)
Var 1. Results for emergency control of Amarunthus spp., Number of individuals/mt2 post-treatment (mean absolute values of three repetitions, 7 DAA and 15 DAA)

| Variable | N | R* | R* Aj | CV |
|---|---|---|---|---|
| Portu7 | 15 | 0.98 | 0.97 | 19.36 |
| Portu15 | 15 | 0.95 | 0.93 | 30.98 |

Table of Variance Analysis (SC type III)

| F.V. | SC | gl | CM | F | p-value |
|---|---|---|---|---|---|
| Model | 32.67 | 4 | 8.17 | 122.50 | <0.0001 |
| Treatment | 32.67 | 4 | 8.17 | 122.50 | <0.0001 |
| Error | 0.67 | 10 | 0.07 | | |
| Total | 33.33 | 14 | | | |
| Model | 54.67 | 4 | 13.67 | 51.25 | <0.0001 |
| Treatment | 54.67 | 4 | 13.67 | 51.25 | <0.0001 |
| Error | 2.67 | 10 | 0.27 | | |
| Total | 57.33 | 14 | | | |
| Test: LSD Fisher Alpha = 0.05 DMS = 0. 46973 | | | | | |
| Error: 0.0667 gl: 10 | | | | | |
| Treatment | | Means | n | E.E. | |
| Control | | 4.00 | 3 | 0.15 | A |
| Sulfent50SC | 1.0 | 1.67 | 3 | 0.15 | B |
| Sulfent10ME | 2.5 | 1.00 | 3 | 0.15 | C |
| Sulfent10ME | 3.5 | 0.00 | 3 | 0.15 | D |
| Sulfent10ME | 3.0 | 0.00 | 3 | 0.15 | D |
| Control | | 5.33 | 3 | 0.30 | A |
| Sulfent10ME | 2.5 | 1.67 | 3 | 0.30 | B |
| Sulfent 50SC | 1.0 | 0.67 | 3 | 0.30 | C |
| Sulfent10ME | 3.0 | 0.67 | 3 | 0.30 | C |
| Sulfent10ME | 3.5 | 0.00 | 3 | 0.30 | C |

Means with a common letter are not significantly different (p > 0.05)
Var 2. Results for emergency control of Portulaca oleacea, Number of individuals/mt2 post-treatment (mean absolute values of three repetitions, 7 DAA and 15 DAA)

| Variable | N | R* | R* Aj | CV |
|---|---|---|---|---|
| Cony7 | 15 | 0.94 | 0.91 | 32.27 |
| Cony15 | 15 | 0.93 | 0.90 | 45.58 |

Table of Variance Analysis (SC type III)

| F.V. | SC | gl | CM | F | p-value |
|---|---|---|---|---|---|
| Model | 40.93 | 4 | 10.23 | 38.38 | <0.0001 |
| Treatment | 40.93 | 4 | 10.23 | 38.38 | <0.0001 |
| Error | 2.67 | 10 | 0.27 | | |
| Total | 43.60 | 14 | | | |
| Model | 45.60 | 4 | 11.40 | 34.20 | <0.0001 |
| Treatment | 45.60 | 4 | 11.40 | 34.20 | <0.0001 |
| Error | 3.33 | 10 | 0.33 | | |
| Total | 48.93 | 14 | | | |
| Test: LSD Fisher Alpha = 0.05 DMS = 0. 93947 | | | | | |
| Error: 0.0667 gl: 10 | | | | | |
| Treatment | | Means | n | E.E. | |
| Control | | 4.67 | 3 | 0.30 | A |
| Sulfent50SC | 1.0 | 1.67 | 3 | 0.30 | B |
| Sulfent10ME | 2.5 | 1.33 | 3 | 0.30 | B |
| Sulfent10ME | 3.0 | 0.33 | 3 | 0.30 | C |
| Sulfent10ME | 3.5 | 0.00 | 3 | 0.30 | C |
| Control | | 4.67 | 3 | 0.33 | A |
| Sulfent10ME | 2.5 | 1.00 | 3 | 0.33 | B |
| Sulfent 50SC | 1.0 | 0.67 | 3 | 0.33 | B |
| Sulfent10ME | 3.0 | 0.00 | 3 | 0.33 | B |
| Sulfent10ME | 3.5 | 0.00 | 3 | 0.33 | B |

Means with a common letter are not significantly different (p > 0.05)
Var 3. Results for emergency control of Conyza bonariensis, Number of individuals/mt2 post-treatment (mean absolute values of three repetitions, 7 DAA and 15 DAA)

Var 4. Results for emergency control of Quenopodium album,
Number of individuals/mt2 post-treatment (mean absolute
values of three repetitions, 7 DAA and 15 DAA)

| Variable | N | R* | R* Aj | CV |
|---|---|---|---|---|
| Queno 7 | 15 | 0.94 | 0.91 | 51.60 |

Table of Variance Analysis (SC type III)

| F.V. | SC | gl | CM | F | p-value |
|---|---|---|---|---|---|
| Model | 29.73 | 4 | 7.43 | 37.17 | <0.0001 |
| Treatment | 29.73 | 4 | 7.43 | 37.17 | <0.0001 |
| Error | 2.00 | 10 | 0.20 | | |
| Total | 31.73 | 14 | | | |

Test: LSD Fisher Alpha = 0.05 DMS = 0.81360
Error: 0.2000 gl: 10

| Treatment | Means | n | E.E. | |
|---|---|---|---|---|
| Control | 3.67 | 3 | 0.26 | A |
| Sulfent50SC 1.0 | 0.33 | 3 | 0.26 | B |
| Sulfent10ME 2.5 | 0.33 | 3 | 0.26 | B |
| Sulfent10ME 3.5 | 0.00 | 3 | 0.26 | B |
| Sulfent10ME 3.0 | 0.00 | 3 | 0.26 | B |
| Variable | N | R* | R* Aj | CV |
| Queno15 | 15 | 0.91 | 0.88 | 57.74 |

Table of Variance Analysis (SC type III)

| F.V. | SC | gl | CM | F | p-value |
|---|---|---|---|---|---|
| Model | 34.67 | 4 | 8.67 | 26.00 | <0.0001 |
| Treatment | 34.67 | 4 | 8.67 | 26.00 | <0.0001 |
| Error | 3.33 | 10 | 0.33 | | |
| Total | 38.00 | 14 | | | |

Test: LSD Fisher Alpha = 0.05 DMS = 1.05035
Error: 0.3333 gl: 10

| Treatment | Means | n | E.E. | |
|---|---|---|---|---|
| Control | 4.00 | 3 | 0.33 | A |
| Sulfent10ME 2.5 | 0.67 | 3 | 0.33 | B |
| Sulfent50SC 1.0 | 0.33 | 3 | 0.33 | B |
| Sulfent10ME 3.5 | 0.00 | 3 | 0.33 | B |
| Sulfent10ME 3.0 | 0.00 | 3 | 0.33 | B |

Means with a common letter are not significantly different (p > 0.05)

### General Comments:

Products such as the one in this study currently constitute fundamental tools for the control of problem weeds, attacking them, directly preventing their emergence.

An adjusted fallow management to reach the sowing in optimal conditions in terms of lot cleaning and good climatic conditions for its activation is required for optimal performance in its pre-emergent action, as in the example analyzed herein, wherein the arrival of the product to the roots of the seedlings in emergence did not have any limitation.

Differential behavior with strong statistical significance is observed with respect to the absolute control and efficacy comparable to the chemical control studied, depending on the test dose and the weed species considered.

### Additional Comments:

The Sulfentrazone 10% ME formulation had an efficient control from 7 dda and was maintained until at least up to 15 dda on the weeds evaluated in the test. The 2.5 l/ha dose of Sulfentrazone 10% ME (treatment 2) showed to have the same performance compared to the doses of the commercial control (Sulfentrazone 50% SC 1 l/ha). From these results we can conclude that the reduction of active ingredient per hectare translates into 50% compared to the chemical control of proven efficacy in the market.

### Final Conclusions of the Comparative Tests 1) to 2)

From the conclusions of the previous tests, the inventors of the present invention unexpectedly found that when sulfentrazone microemulsion was used at low concentration, it presented a reduction in the application dose compared to when sulfentrazone 50 EC was used in the treatment of sunflower weeds.

This result is not expected since the active ingredient used in both cases is the same and the person skilled in the art would suppose that both types of formulation would be applied at the same dose.

In addition to the previously described main advantage of showing a reduction in the application dose, and by virtue of the combination of the other components of the microemulsion formulations that the investigators used for this embodiment, the present sulfentrazone microemulsion formulation offered protection against physicochemical losses (evaporation, rolling, etc); improvement of the absorption rate; significant reduction in environmental impact variables; drastic reduction of solvent evaporation; allowing keeping the active ingredients in liquid phase; allowing hydrophobic active ingredients to be solubilized in water; a large increase in the Surface/Volume ratio and controlled release of active ingredients.

Combination of sulfentrazone compositions in the form of a 10% w/v microemulsion with compositions of glyphosate, 2-4 D, acetochlor, metribuzin, clethodim, imazethapyr and paraquat

The 10% w/v sulfentrazone microemulsion compositions developed in the present description were combined with commercial compositions of glyphosate 11% ME, glyphosate potassium salt 66.2% w/v SL, 2.4 D 30% w/v ME, 2.4 D dimethyl amine salt 60% w/v SL, acetochlor 90% EC, metribuzin 20% w/v ME, clethodim 24% w/v ME, clethodim 24% w/v EC, imazethapyr 4.5% w/v ME and paraquat 27% w/v SL at different volume ratios in binary compositions, and up to 5 components, the stability in hours being measured by the Emulsion Test, comparing them with the formulations broths containing sulfentrazone 50% EC as a control, in all cases where the present formulation of Sulfentrazone 10% ME was used as a component, wherein it was unexpectedly found that the mixture showed comparable stability within 24 hours after preparation, which is a more than acceptable time to mix the products in formulation tanks at the corresponding dilution for application to crops, as can be

| | | | Stability of the | | | | Stability of the | | | | Stability of the | | | | Stability of the | | | |
|---|---|---|---|---|---|---|---|---|---|---|---|---|---|---|---|---|---|---|
| | | Active | broth with final | | | | broth with final | | | | broth with final | | | | broth with final | | | |
| | Quan- | ingredient | volume of 10 ml | | | | volume of 20 ml | | | | volume of 40 ml | | | | volume of 80 ml | | | |
| | tity | formulations | 30 | 2 | 4 | 24 | 30 | 2 | 4 | 24 | 30 | 2 | 4 | 24 | 30 | 2 | 4 | 24 |
| Tests | ml | in % w/V | min | h | h | h | min | h | h | h | min | h | h | h | min | h | h | h |
| 1 | 2.5 | Sulfentrazone | “++” | “++” | “++” | “++” | “++” | “++” | “++” | “++” | “++” | “++” | “++” | “++” | “++” | “++” | “++” | “++” |
| | | 10% ME | | | | | | | | | | | | | | | | |
| 1′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| 2 | 2.5 | Sulfentrazone | “++” | “++” | “++” | “++” | “++” | “++” | “++” | “++” | “++” | “++” | “++” | “++” | “++” | “++” | “++” | “++” |
| | | 10% ME | | | | | | | | | | | | | | | | |
| | 3 | Glyphosate | | | | | | | | | | | | | | | | |
| | | 11% ME | | | | | | | | | | | | | | | | |
| 2′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 3 | Glyphosate | | | | | | | | | | | | | | | | |
| | | 11% ME | | | | | | | | | | | | | | | | |
| 3 | 2.5 | Sulfentrazone | “++” | “++” | “++” | “++” | “++” | “++” | “−” | “++” | “++” | “++” | “++” | “++” | “++” | “++” | “++” | “++” |
| | | 10% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| 3′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| 4 | 2.5 | Sulfentrazone | “++” | “++” | “++” | “++” | “++” | “++” | “++” | “++” | “++” | “++” | “++” | “++” | “++” | “++” | “++” | “++” |
| | | 10% ME | | | | | | | | | | | | | | | | |
| | 1 | 2.4 D 30% | | | | | | | | | | | | | | | | |
| | | w/V ME | | | | | | | | | | | | | | | | |
| 4′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1 | 2.4 D 30% | | | | | | | | | | | | | | | | |
| | | w/V ME | | | | | | | | | | | | | | | | |
| 5 | 2.5 | Sulfentrazone | “++” | “++” | “++” | “+” | “++” | “++” | “++” | “+” | “++” | “++” | “++” | “+” | “++” | “++” | “++” | “+” |
| | | 10% ME | | | | | | | | | | | | | | | | |
| | 1.2 | 2.4 D DMA salt | | | | | | | | | | | | | | | | |
| | | 60% w/V SL | | | | | | | | | | | | | | | | |
| 5′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.2 | 2.4 D DMA salt | | | | | | | | | | | | | | | | |
| | | 60% w/V SL | | | | | | | | | | | | | | | | |
| 7 | 2.5 | Sulfentrazone | “++” | “++” | “++” | “+” | “++” | “++” | “−” | “−” | “++” | “++” | “−” | “−” | “++” | “++” | “−” | “−” |
| | | 10% ME | | | | | | | | | | | | | | | | |
| | 1.2 | Acetochlor | | | | | | | | | | | | | | | | |
| | | 90% EC | | | | | | | | | | | | | | | | |
| 7′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.2 | Acetochlor | | | | | | | | | | | | | | | | |
| | | 90% EC | | | | | | | | | | | | | | | | |
| 8 | 2.5 | Sulfentrazone | “++” | “++” | “++” | “++” | “++” | “++” | “++” | “++” | “++” | “++” | “++” | “++” | “++” | “++” | “++” | “++” |
| | | 10% ME | | | | | | | | | | | | | | | | |
| | 4 | 2.4 D 8% | | | | | | | | | | | | | | | | |
| | | w/V ME + | | | | | | | | | | | | | | | | |
| | | Glyphosate | | | | | | | | | | | | | | | | |
| | | 11% w/V ME | | | | | | | | | | | | | | | | |
| 8′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 4 | 2.4 D 8% | | | | | | | | | | | | | | | | |
| | | w/V ME + | | | | | | | | | | | | | | | | |
| | | Glyphosate | | | | | | | | | | | | | | | | |
| | | 11% w/V ME | | | | | | | | | | | | | | | | |
| 9 | 2.5 | Sulfentrazone | “++” | “++” | “++” | “++” | “++” | “++” | “++” | “−” | “++” | “++” | “++” | “−” | “++” | “++” | “++” | “−” |
| | | 10% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1 | 2.4 D 30% | | | | | | | | | | | | | | | | |
| | | w/V ME | | | | | | | | | | | | | | | | |
| 9′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 2 | Glyphosate | | | | | | | | | | | | | | | | |
| | | potassium salt | | | | | | | | | | | | | | | | |
| | | 66.2% w/v BL | | | | | | | | | | | | | | | | |
| | 1 | 2.4D 30% | | | | | | | | | | | | | | | | |
| | | w/V ME | | | | | | | | | | | | | | | | |
| 10 | 2.5 | Sulfentrazone | “++” | “++” | “++” | “++” | “+” | “+” | “+” | “+” | “++” | “+” | “+” | “+” | “++” | “+” | “+” | “+” |
| | | 10% ME | | | | | | | | | | | | | | | | |
| | 1.5 | Metribuzin | | | | | | | | | | | | | | | | |
| | | 20% ME | | | | | | | | | | | | | | | | |
| | 3 | Glyphosate | | | | | | | | | | | | | | | | |
| | | 11% ME | | | | | | | | | | | | | | | | |
| | 1 | 2.4D 30% ME | | | | | | | | | | | | | | | | |
| | 1.2 | Clethodim | | | | | | | | | | | | | | | | |
| | | 24% ME | | | | | | | | | | | | | | | | |
| 10′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.5 | Metribuzin | | | | | | | | | | | | | | | | |
| | | 20% ME | | | | | | | | | | | | | | | | |
| | 3 | Glyphosate | | | | | | | | | | | | | | | | |
| | | 11% ME | | | | | | | | | | | | | | | | |
| | 1 | 2.4D 30% ME | | | | | | | | | | | | | | | | |
| | 1.2 | Clethodim | | | | | | | | | | | | | | | | |
| | | 24% ME | | | | | | | | | | | | | | | | |
| 11 | 2.5 | Sulfentrazone | “−” | “−” | “−” | “−” | “−” | “−” | “−” | “−” | “−” | “−” | “−” | “−” | “−” | “−” | “−” | “−” |
| | | 10% ME | | | | | | | | | | | | | | | | |
| | 1 | Metribuzin | | | | | | | | | | | | | | | | |
| | | 48% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1.2 | 2.4 D DMA salt | | | | | | | | | | | | | | | | |
| | | 60% w/V SL | | | | | | | | | | | | | | | | |
| | 1.2 | Clethodim | | | | | | | | | | | | | | | | |
| | | 24% EC | | | | | | | | | | | | | | | | |
| | 1.2 | Acetochlor | | | | | | | | | | | | | | | | |
| | | 90% EC | | | | | | | | | | | | | | | | |
| 11′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1 | Metribuzin | | | | | | | | | | | | | | | | |
| | | 48% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1.2 | 2.4 D DMA salt | | | | | | | | | | | | | | | | |
| | | 60% w/V SL | | | | | | | | | | | | | | | | |
| | 1.2 | Clethodim | | | | | | | | | | | | | | | | |
| | | 24% EC | | | | | | | | | | | | | | | | |
| | 1.2 | Acetochlor | | | | | | | | | | | | | | | | |
| | | 90% EC | | | | | | | | | | | | | | | | |
| 12 | 2.5 | Sulfentrazone | “++” | “++” | “++” | “++” | “++” | “++” | “++” | “++” | “++” | “++” | “++” | “++” | “++” | “++” | “++” | “++” |
| | | 10% ME | | | | | | | | | | | | | | | | |
| | 1 | Imazethapyr | | | | | | | | | | | | | | | | |
| | | 4.5% ME | | | | | | | | | | | | | | | | |
| | 3 | Glyphosate | | | | | | | | | | | | | | | | |
| | | 11% ME | | | | | | | | | | | | | | | | |
| | 1 | 2.4D 30% ME | | | | | | | | | | | | | | | | |
| 12′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1 | Imazethapyr | | | | | | | | | | | | | | | | |
| | | 4.5% ME | | | | | | | | | | | | | | | | |
| | 3 | Glyphosate | | | | | | | | | | | | | | | | |
| | | 11% ME | | | | | | | | | | | | | | | | |
| | 1 | 2.4D 30% ME | | | | | | | | | | | | | | | | |
| 13 | 2.5 | Sulfentrazone | “+” | “+” | “+” | “+” | “++” | “++” | “++” | “++” | “++” | “++” | “+” | “+” | “++” | “++” | “++” | “+” |
| | | 10% ME | | | | | | | | | | | | | | | | |
| | 1.5 | Metribuzin | | | | | | | | | | | | | | | | |
| | | 20% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1 | 2.4D 30% ME | | | | | | | | | | | | | | | | |
| 13′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.5 | Metribuzin | | | | | | | | | | | | | | | | |
| | | 20% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1 | 2.4D 30% ME | | | | | | | | | | | | | | | | |
| 14 | 2.5 | Sulfentrazone | “+” | “+” | “+” | “−” | “++” | “++” | “++” | “−” | “++” | “++” | “++” | “+” | “++” | “++” | “++” | “+” |
| | | 10% ME | | | | | | | | | | | | | | | | |
| | 1.2 | Clethodim | | | | | | | | | | | | | | | | |
| | | 24% ME | | | | | | | | | | | | | | | | |
| | 3 | Glyphosate | | | | | | | | | | | | | | | | |
| | | 11% ME | | | | | | | | | | | | | | | | |
| | 1 | 2.4D 30% ME | | | | | | | | | | | | | | | | |
| | 1.5 | Metribuzin | | | | | | | | | | | | | | | | |
| | | 20% ME | | | | | | | | | | | | | | | | |
| 14′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.2 | Clethodim | | | | | | | | | | | | | | | | |
| | | 24% ME | | | | | | | | | | | | | | | | |
| | 3 | Glyphosate | | | | | | | | | | | | | | | | |
| | | 11% ME | | | | | | | | | | | | | | | | |
| | 1 | 2.4D 30% ME | | | | | | | | | | | | | | | | |
| | 1.5 | Metribuzin | | | | | | | | | | | | | | | | |
| | | 20% ME | | | | | | | | | | | | | | | | |
| 15 | 2.5 | Sulfentrazone | “−” | “−” | “−” | “−” | “++” | “+” | “+” | “−” | “++” | “++” | “++” | “−” | “++” | “++” | “+” | “−” |
| | | 10% ME | | | | | | | | | | | | | | | | |
| | 1.2 | Clethodim | | | | | | | | | | | | | | | | |
| | | 24% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1 | 2.4D 30% ME | | | | | | | | | | | | | | | | |
| 15′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.2 | Clethodim | | | | | | | | | | | | | | | | |
| | | 24% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1 | 2.4D 30% ME | | | | | | | | | | | | | | | | |
| 16 | 2.5 | Sulfentrazone | “−” | “−” | “−” | “−” | “++” | “+” | “+” | “−” | “++” | “++” | “+” | “−” | “++” | “++” | “+” | “−” |
| | | 10% ME | | | | | | | | | | | | | | | | |
| | 1.2 | Clethodim | | | | | | | | | | | | | | | | |
| | | 24% ME | | | | | | | | | | | | | | | | |
| | 2 | Glyphosate | | | | | | | | | | | | | | | | |
| | | potassium salt | | | | | | | | | | | | | | | | |
| | | 66.2% w/v SL | | | | | | | | | | | | | | | | |
| | 1.2 | 2.4 D DMA salt | | | | | | | | | | | | | | | | |
| | | 60% w/V SL | | | | | | | | | | | | | | | | |
| 16′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.2 | Clethodim | | | | | | | | | | | | | | | | |
| | | 24% ME | | | | | | | | | | | | | | | | |
| | 2 | Glyphosate | | | | | | | | | | | | | | | | |
| | | potassium salt | | | | | | | | | | | | | | | | |
| | | 66.2% w/V SL | | | | | | | | | | | | | | | | |
| | 1.2 | 2.4 D DMA salt | | | | | | | | | | | | | | | | |
| | | 60% w/V SL | | | | | | | | | | | | | | | | |
| 17 | 2.5 | Sulfentrazone | “++” | “++” | “++” | “++” | “++” | “++” | “++” | “++” | “++” | “++” | “++” | “++” | “++” | “++” | “++” | “++” |
| | | 10% ME | | | | | | | | | | | | | | | | |
| | 1.2 | Parquat 27% SL | | | | | | | | | | | | | | | | |
| 17′ | 1.5 | Sulfentrazone | “−” | “−” | “−” | “−” | “−” | “−” | “−” | “−” | “−” | “−” | “−” | “−” | “−” | “−” | “−” | “−” |
| | | 50% SC | | | | | | | | | | | | | | | | |
| | 1.2 | Parquat 27% SL | | | | | | | | | | | | | | | | |

Criterion:
“++” stable broth
“+” regular broth (can be applied)
“−” non-stable broth
Glyphosate potassium salt, the amount of AI in the form of salt 54% w/V is expressed as acid equivalent
2.4 D DMA salt, the amount of AI in the form of salt 50% w/V is expressed as acid equivalent
Notation:
SC [symbol] ed suspension
SL Soluble concentrate
EC Emulsifiable Concentrate
ME Microemulsion
DAA Days Before Application [symbol]
indicates data missing or illegible when filed

determined from the following table:

### AI Retention Test in Soybean Stubble:

In order to determine the retention of the composition of Sulfentrazone 10% ME in the soy stubble with respect to the composition of sulfentrazone 50% SC, the following test was carried out:

### Materials

250 ml beaker
Mosquito net type fabric—mesh #14 (prepared in a concave shape with a central depth of 3 cm and a total diameter of 8 cm)
Soy stubble
Hard water (500 mg/Kg as CaCO3)
Magnetic stirrer
Magnet

### Preparation

Cut the stubble to a length of 3 cm, trying to select different diameters, but discarding the thick stems.

Arrange the stubble in the fabric in such a way as to achieve a height of 2.5 cm in the center, accommodating them so that there is a minimum layer on the edges. Not exceeding 7 cm in diameter. Stubble added weight is controlled at 2.30 g in all tests.

Prepare the 100 ml application broth; it is prepared at 5% w/w. It is homogenized in the beaker with the magnet and an aliquot is taken and stored (it is taken as an initial sample of 10 ml for checking the concentration by HPLC).

### Methodology

The broth is poured over the prepared stubble bed, taking care to wet everything and not to concentrate everything in the center.

It is allowed to drain for a time in which it is not noticeable that drops fall, and the stubble filter is removed, a magnet is placed in the beaker to homogenize the broth and then a sample is taken (it is taken as a final sample of 10 ml for checking the concentration by HPLC).

Once the two concentration readings are obtained, they are compared. The percentage of active ingredient loss is calculated and reported as % retained in stubble.

### Results

According to the above methodology, in two separate tests 100 ml of 5% broth prepared of sulfentrazone 10% ME and sulfentrazone 50% SC was poured on two separate beds of soybean stubble prepared as indicated above.

An aliquot of each poured liquid that passed through the soybean stubble bed was taken and the percentage of Sulfentrazone retained in the stubble was determined based thereon.

The results are summarized in the following table:

| | | | Retained in |
|---|---|---|---|
| Active | 5% broth in | | soybean |
| ingredient | hard water | Formulate | stubble |
| Sulfentrazone | 100 ml | Sulfentrazone | 0% |
| | | 10% ME | |
| | 100 ml | Sulfentrazone | 4% |
| | | 50% SC | |

### CONCLUSION

The soybean stubble treated with sulfentrazone 50% SC would be contaminated with sulfentrazone while the one treated with sulfentrazone 10% ME of the present invention shall have no sulfentrazone residue after harvesting.

The test on soybean crop stubble shows that the ME formulation does not allow sulfentrazone to be retained in the stubble, while in the traditional 50% SC formulation, the sulfentrazone is retained.

1. A sulfentrazone composition in the form of a microemulsion the composition comprising from 5 to 15% weight by volume of sulfentrazone, a dipolar aprotic organic solvent that comprises from 46 to 50% w/v, a polar solvent that comprises from 0 to 4.0% w/v, wetting agents 20% or 41% w/v, a coadjuvant from 0 to 6% w/v, and a non-ionic surfactant from 0 to 3.5% w/v, adjuvant from 0 to 17.5% w/v and dispersing agents from 0 to 2% w/v.

2. The sulfentrazone composition in the form of a microemulsion according to claim 1, wherein the aprotic dipolar organic solvent is N-methylpyrrolidone.

3. The sulfentrazone composition in the form of a microemulsion according to claim 1, wherein polar solvent is glacial acetic acid or water.

4. The sulfentrazone composition in the form of a microemulsion according to claim 1, wherein the wetting agent is nonyl phenol polyethylene 10.06% w/w or wetting agent based on saturated and unsaturated fatty acids dimethylaminopropalamide.

5. The sulfentrazone composition in the form of a microemulsion according to claim 1, wherein the non-ionic surfactant comprises castor oil ethoxylated with 36 moles of ethylene oxide.

6. The sulfentrazone composition in the form of a microemulsion according to claim 1, wherein the coadjuvant is a soybean oil fatty acid methyl ester.

7. The sulfentrazone composition in the form of a microemulsion according to claim 1, wherein the dispersing agent is polymethylmethacrylate-polyethylene glycol graft copolymer.

8. The sulfentrazone composition in the form of a microemulsion according to claim 1, wherein the adjuvant is selected from fatty tallow alkyl amine ethoxylated with 15 moles of ethylene oxide or coconut fatty amine ethoxylated with 10-15 moles of ethylene oxide.

9. The sulfentrazone composition in the form of a microemulsion according to claim 1, comprising the following component ratio 10.0% w/v sulfentrazone, 48% w/v N-methylpyrrolidone, 15.0% w/v coconut fatty amine ethoxylated with 10-15 moles of ethylene oxide, 20% w/v polyethylene nonyl phenol 10.06% w/w, 5% w/v soybean oil fatty acid methyl ester, 2% w/v polymethylmethacrylate-polyethylene glycol graft copolymer, 3.5% w/v castor oil ethoxylated with 36 moles of ethylene oxide.

10. The sulfentrazone composition in the form of a microemulsion according to claim 1, comprising the following component ratio 10.0% w/v sulfentrazone, 46% w/v N-methylpyrrolidone, 41% w/v wetting agent based on saturated and unsaturated fatty acids dimethylaminopropalamide and 3.5% w/v glacial acetic acid.

11. The sulfentrazone composition in the form of a microemulsion according to claim 1, comprising the following component ratio 10.0% w/v sulfentrazone, 46% w/v N-methylpyrrolidone, 17.5% w/v coconut fatty amine ethoxylated with 10-15 moles of ethylene oxide, 21.5% w/v polyethylene nonyl phenol 10.06% w/w, 5% w/v soybean oil fatty acid methyl ester, and 2% w/v polymethylmethacrylate-polyethylene glycol graft copolymer.

12. The sulfentrazone composition in the form of a microemulsion according to claim 1, comprising the following component ratio 5.0% w/v sulfentrazone, 48% w/v N-methylpyrrolidone, 15.0% w/v coconut fatty amine ethoxylated with 10-15 moles of ethylene oxide, 20.0% w/v polyethylene nonyl phenol 10.06% w/w, 6% w/v soybean oil fatty acid methyl ester, 2% w/v polymethylmethacrylate-polyethylene glycol graft copolymer, 3.5% w/v castor oil ethoxylated with 36 moles of ethylene oxide and 4% w/v water.

13. The sulfentrazone composition in the form of a microemulsion according to claim 1, comprising the following component ratio 10.0% w/v sulfentrazone, 46% w/v N-methylpyrrolidone, 15.0% w/v coconut fatty amine ethoxylated with 10-15 moles of ethylene oxide, 20.0% w/v polyethylene nonyl phenol 10.06% w/w, 5% w/v soybean oil fatty acid methyl ester, 2% w/v polymethylmethacrylate-polyethylene glycol graft copolymer, 3.5% w/v castor oil ethoxylated with 36 moles of ethylene oxide and 2% w/v water.

14. The sulfentrazone composition in the form of a microemulsion according to claim 1, comprising the following component ratio 15.0% w/v sulfentrazone, 48% w/v N-methylpyrrolidone, 15.0% w/v coconut fatty amine ethoxylated with 10-15 moles of ethylene oxide, 20.0% w/v polyethylene nonyl phenol 10.06% w/w, 1% w/v soybean oil fatty acid methyl ester, 2% w/v polymethylmethacrylate-polyethylene glycol graft copolymer, 3.5% w/v castor oil ethoxylated with 36 moles of ethylene oxide and 1% w/v water.

15. The sulfentrazone composition in the form of a microemulsion according to claim 1, combined with compositions of glyphosate 11% ME, glyphosate potassium salt 66.2% w/v SL, 2.4 D, 2.4 D dimethyl amine salt, acetochlor, metribuzin, clethodim, imazethapyr and paraquat before being diluted with water for subsequent application.

16. The sulfentrazone composition in the form of a microemulsion according to claim 15, wherein the sulfentrazone composition in the form of a microemulsion is combined with glyphosate 11% ME, and/or glyphosate potassium salt 66.2% w/v SL, and/or 2.4 D 30% w/v ME, and/or 2.4 D dimethyl amine salt 60% w/v SL, and/or acetochlor 90% w/v EC, and/or metribuzin 20% w/v ME, and/or clethodim 24% w/v ME, and/or clethodim 24% w/v EC, and/or imazethapyr 4.5% w/v ME and/or paraquat 27% w/v SL.

17. The sulfentrazone composition in the form of a microemulsion according to claim 16, wherein the combination ratio of sulfentrazone composition 10% w/v ME:glyphosate composition 11% w/v ME in a binary mixture is 2.5:3.0 v/v.

18. The sulfentrazone composition in the form of a microemulsion according to claim 16, wherein the combination ratio of sulfentrazone composition 10% w/v ME:Glyphosate Potassium Salt composition 66.2% w/v SL in a binary mixture is 2.5:2.0 v/v.

19. The sulfentrazone composition in the form of a microemulsion according to claim 16, wherein the combination ratio of sulfentrazone composition 10% w/v ME: 2.4 D composition 30% p/v ME in a binary mixture is 2.5:1.0 v/v.

20. The sulfentrazone composition in the form of a microemulsion according to claim 16, wherein the combination ratio of sulfentrazone composition 10% w/v ME: 2.4 D dimethyl amine salt (DMA) composition 60% w/v SL or acetochlor 90% w/v EC in a binary mixture is 2.5:1.2 v/v.

21. The sulfentrazone composition in the form of a microemulsion according to claim 16, wherein the combination ratio of sulfentrazone composition 10% w/v ME: 2.4 D composition 8% w/V ME+Glyphosate 11% w/V ME in a mixture is 2.5:4.0 v/v.

22. The sulfentrazone composition in the form of a microemulsion according to claim 16, wherein the combination ratio of sulfentrazone composition 10% w/v ME:glyphosate Potassium Salt composition 66.2% w/V SL: 2.4 D composition 30% w/V ME in a ternary mixture is 2.5:2:1.

23. The sulfentrazone composition in the form of a microemulsion according to claim 16, wherein the combination ratio of sulfentrazone composition 10% w/v ME:metribuzin composition 20% w/v ME:glyphosate composition 11% w/v ME: 2,4D composition 30% w/v ME:Clethodim composition 24% w/v ME is in a mixture of five components 2.5:1.5:3:1:1.2.

24. The sulfentrazone composition in the form of a microemulsion according to claim 16, wherein the combination ratio of sulfentrazone composition 10% w/v ME:metribuzin composition 48% w/v:Glyphosate Potassium Salt composition 66.2% w/v SL: 2.4 D salt DMA composition 60% w/V SL:clethodim composition 24% EC:Acetochlor composition 90% w/v EC in a mixture of six components is 2.5:1:2:1.2:1.2:1.2.

25. The sulfentrazone composition in the form of a microemulsion according to claim 16, wherein the combination ratio of sulfentrazone composition 10% w/v ME:Imazethapyr composition 4.5% w/v ME:Glyphosate composition 11% w/v ME: 2.4D composition 30% w/v ME in a quaternary mixture is 2.5:1:3:1.

26. The sulfentrazone composition in the form of a microemulsion according to claim 16, wherein the combination ratio of sulfentrazone composition 10% w/v ME:Metribuzin composition 20% w/v ME:Glyphosate Potassium Salt composition 66.2% w/v SL: 2,4D composition 30% p/v ME in a quaternary mixture is 2.5:1.5:2:1.

27. The sulfentrazone composition in the form of a microemulsion according to claim 16, wherein the combination ratio of sulfentrazone composition 10% w/v ME:Clethodim composition 24% w/v ME:Glyphosate composition 11% w/v ME: 2,4D composition 30% p/v ME:Metribuzin composition 20% w/v ME in a mixture of five components is 2.5:1.2:3:1:1.5.

28. The sulfentrazone composition in the form of a microemulsion according to claim 16, wherein the combination ratio of sulfentrazone composition 10% w/v ME:Clethodim composition 24% w/v ME:Glyphosate Potassium Salt composition 66.2% w/v SL: 2.4 D 30% w/V ME in a quaternary mixture is 2.5:1.2:2:1.

29. The sulfentrazone composition in the form of a microemulsion according to claim 16, wherein the combination ratio of sulfentrazone composition 10% w/v ME:Clethodim composition 24% w/v ME:Glyphosate Potassium Salt composition 66.2% w/v SL: 2.4 D DMA salt 60% w/V SL in a quaternary mixture is 2.5:1.2:2:1.

30. The sulfentrazone composition in the form of a microemulsion according to claim 16, wherein the combination ratio of sulfentrazone composition 10% w/v ME:Paraquat composition 27% w/v SL in a binary mixture is 2.5:1.2.
